(19) United States
(12) Patent Application Publication
(10) Pub. No.: US 2005/0013934 A1
(43) Pub. Date: Jan. 20, 2005

(54) Process for the preparation of a pigment comprising a core material and at least one dielectric layer

(76) Inventors: Rong Xiong, Dobbs Ferry, NY (US); Stephen Daniel Pastor, Mayhill, NM (US); Patrice Bujard, Courtepin (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/870,644

(22) Filed: Jun. 10, 2004

Related U.S. Application Data
(60) Provisional application No. 60/479,010, filed on Jun. 17, 2003.
(60) Provisional application No. 60/479,071, filed on Jun. 17, 2003.
(60) Provisional application No. 60/479,012, filed on Jun. 17, 2003.

(51) Int. Cl. C09C 1/62; C04B 2/00; C04B 14/20; B32B 5/16; B22F 7/08; B32B 27/08

(52) U.S. Cl. 427/212; 106/415; 106/417; 106/403; 106/404; 106/481; 106/482; 428/403; 427/508; 427/514; 428/518; 428/553; 427/215; 427/218

(57) ABSTRACT

The present invention relates to a process for the preparation of a pigment comprising a core material and at least one dielectric layer using microwave deposition of a metal oxide from an aqueous solution of fluorine scavenger onto a core material.

This application claims the benefit of U.S. Provisional Application No. 60/479,010 filed Jun. 17, 2003 and of U.S. Provisional Application No. 60/479,071 filed Jun. 17, 2003 and U.S. Provisional Application No. 60/479,012 filed Jun. 17, 2003.

The invention relates to a process for the preparation of a pigment comprising a core material and at least one dielectric layer using microwave deposition of a metal oxide from an aqueous solution of precursor material onto a core material.

### BACKGOUND OF THE INVENTION

Effect pigments have historically been manufactured by one of two methods. In the first method, as described for example in U.S. Pat. No. 3,438,796, a goniochromatic effect pigment that displays an angle-dependent color change and consists of a central opaque aluminum film symmetrically coated with a relatively thick layer of SiO₂, a transparent aluminum film and a thick SiO₂ film is formed by coating a substrate film alternately with SiO₂ and aluminum vapor under a high level of vacuum and scraping or otherwise removing the resulting multiplayer structure from the substrate to provide pigment particles.

A refinement of the foregoing process is described, for example, in U.S. Pat. No. 5,135,812. This patent describes a process in which multiple layers are formed by vacuum deposition on either a soluble web, which is then dissolved to provide a sheet of the multiple structure which breaks into pieces upon dissolution of the web to provide pigment particles, or on a release layer provided on a flexible web. In the latter case, the multilayer structure is released and broken apart upon flexing of the web to provide particles that are then comminuted to the desired size. Both of these procedures require multiple coating and/or vacuum deposition steps, which must be precisely controlled in order to provide a suitable effect pigment. Due to the number of steps involved in the process, the specialized equipment and precise process control that is required, the resulting pigments are extremely expensive.

Methods involving deposition of a metal oxide layer via liquid phase decomposition (hydrolysis) of a corresponding salt (i.e. sulfate or halide) are known per se and have been used to form luster, or pearlescent pigments which have translucent mica core materials. However, such methods, described for example in U.S. Pat. No. 3,087,827 and U.S. Pat. No. 5,733,371, have not been considered suitable for forming effect pigments with reflective metallic cores in the highly acid (ph of less than 4), aqueous solutions required by such processes.

Use of microwave energy for the deposition of metal oxide films onto glass and indium tin oxide coated glass plates used for LED devices is known and disclosed in numerous journal articles such as E. Vigil, L. Saadoun, Thin Solid Films 2000, 365, 12-18 and E. Vigil, L. Saadoun, J. Materials Science Letters 1999, 18 1067-1069. Good adhesion was obtained only on indium tin oxide coated glass plates, which the authors suggested was due to some electron donation ability of the indium tin oxide coating (see Vigil, E.; Ayllón, J. A.; Peiró, A. M.; Rodriguez-Clemente, R.; Domènech, X.; Peral, J. Langmuir 2001, 17, 891).

The bulk precipitation of metal oxide particles by microwave irradiation is, for example, described in (1) Lerner, E.; Sarig, S.; Azoury, R. Journal of Materials Science: Materials in Medicine 1991, 2, 138 (2) Daichuan, D.; Pinjie, H.; Shushan, D. Materials Research Bulletin, 1995, 30, 537 (3) Leonelli, C. et al. Microwaves: Theory and Applications in Materials Processing 2001, 111, 321, (4) Girnus, I. et al. Zeolites 1995, 15, 33, (5) Rodriguez-Clemente, R. et al. Journal of Crystal Growth 1996, 169, 339 and (6) Daichuan, D.; Pinjie, H.; Shushan, D. Materials Research Bulletin, 1995, 30, 531.

Surprisingly, applicants have found that use of the microwave deposition process of the present invention allows for a process for the deposition of uniform, semi-transparent or transparent, thin film layers of metal oxides on cores of uniform thickness which thickness can be adjusted based upon mass ratio of core material to metal oxide (mass of metal oxide precursor material) allowing for the preparation of thin films of metal oxides of a variety of thicknesses depending upon the desired effect without precipitation of the metal oxide. When the metal oxide layer is made with liquid phase deposition, and conventional heating is applied, energy is transferred from surface to the bulk mixture and eventually to the substrate material. With microwave treatment, energy is focused on the substrate material due to the better absorbance of the microwave energy by the substrate than the bulk mixture. This will make the substrate the reaction center, which allows the reaction to take place with higher probability at the surface of the substrate. Reaction at the surface results in better adhesion of the coating layer and significantly less bulk precipitation. The good surface adhesion, easy adjustment of reaction conditions to change the thickness or composition of the coating, as well as minimal deposition into the bulk media provide a significant advantage of the instant invention over the prior art.

Accordingly, the present invention is directed to a process for the preparation of a pigment comprising a core material and at least one dielectric layer consisting of one or more oxides of a metal selected from the group 3 to 15 of the periodic table, comprising the steps of:
(a) suspending the core material in an aqueous solution of a fluorine scavenger;
(b) adding an aqueous solution of one or more fluorine containing metal complexes which are the precursors of the desired metal oxide coating; and
(c) subjecting said suspension to microwave radiation to deposit the metal oxide onto said core material.

Steps (b) and (c) can optionally be repeated using different fluorine containing metal complexes to produce one or more metal oxide layers or a gradient of concentration of 2 different metal oxides across the thickness.

These layers may alter the optical goniochromatic properties because of their different refractive indices, or affect other properties, such as, to catalyze the formation of certain morphology or suppress photoactivity.

In a first preferred embodiment the present invention relates to a process for the preparation of coated pigment particles comprising a pigment particle and at least one dielectric layer consisting of one or more oxides of a metal selected from the group 3 to 15 of the periodic table, comprising the steps of:
(a) suspending the pigment particle in an aqueous solution of fluorine scavenger;
(b) adding an aqueous solution of one or more fluorine containing metal complexes which are the precursors of the desired metal oxide coating; and
(c) subjecting said suspension to microwave radiation to deposit the metal oxide onto said pigment particle, wherein steps (b) and (c) can optionally be repeated using different fluorine containing metal complexes to produce one or more metal oxide layers.

Steps b) and c) can also optionally be done by starting with a first fluorine containing metal complex and then adding continously a second, but different, fluorine containing metal complex, leading to a metal oxide layer made of 2 different metal oxides.

The coating of a pigment particle with metal oxide layer(s) modifies the desired physical properties of the pigment particles such as optical reflectivity, hydrophilicity (rheology improvement), weatherfastness, conductivity (requires a conductive layer, for instance, tin oxide), photoactivity, etc. Preferably, the fluorine containing metal complex(s) is (are) added continuously to the suspension of pigment particles in the solution of fluorine scavenger.

In said embodiment inorganic or organic pigments are used as core materials. Suitable organic pigments are, for example, described in W. Herbst and K. Hunger, VCH Verlagsgesellschaft mbH, Weinheim/New York, 2nd, completely revised edition, 1995 and are, for example, selected from the group consisting of azo, azomethine, methine, anthraquinone, phthalocyanine, perinone, perylene, diketopyrrolopyrrole, thioindigo, iminoisoindoline, dioxazine, iminoisoindolinone, quinacridone, flavanthrone, indanthrone, anthrapyrimidine and quinophthalone pigments, or a mixture or solid solution thereof; especially an azo, dioxazine, perylene, diketopyrrolopyrrole, quinacridone, phthalocyanine, indanthrone or iminoisoindolinone pigment, or a mixture or solid solution thereof.

Notable pigments useful in the present invention are those pigments described in the Color Index, including the group consisting of C.I. Pigment Red 202, C.I. Pigment Red 122, C.I. Pigment Red 179, C.I. Pigment Red 170, C.I. Pigment Red 144, C.I. Pigment Red 177, C.I. Pigment Red 254, C.I. Pigment Red 255, C.I. Pigment Red 264, C.I. Pigment Brown 23, C.I. Pigment Yellow 109, C.I. Pigment Yellow 110, C.I. Pigment Yellow 147, C.I. Pigment Yellow 191.1, C.I. Pigment Yellow 74, C.I. Pigment Yellow 83, C.I. Pigment Yellow 13, C.I. Pigment Orange 61, C.I. Pigment Orange 71, C.I. Pigment Orange 73, C.I. Pigment Orange 48, C.I. Pigment Orange 49, C.I. Pigment Blue 15, C.I. Pigment Blue 60, C.I. Pigment Violet 23, C.I. Pigment Violet 37, C.I. Pigment Violet 19, C.I. Pigment Green 7, and C.I. Pigment Green 36, or a mixture or solid solution thereof.

Another preferred pigment is the condensation product of 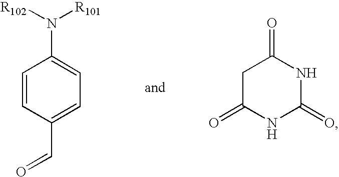
wherein R₁₀₁ and R₁₀₂ are independently hydrogen or C₁-C₁₈ alkyl, such as for example, methyl, ethyl, n-propyl, isopropyl, n-butyl, sec-butyl, isobutyl, tert-butyl, n-amyl, tert-amyl, hexyl, heptyl, octyl, 2-ethylhexyl, nonyl, decyl, dodecyl, tetradecyl, hexadecyl or octadecyl. Preferably R₁₀₁ and R₁₀₂ are methyl. The condensation product is of formula

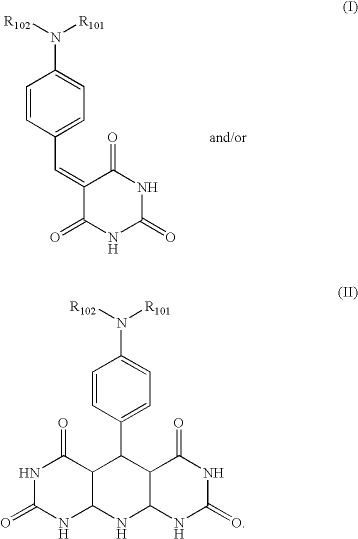

Suitable inorganic pigments useful in the present invention are selected from the group consisting of carbon black, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, and bismuth vanadate, and mixtures thereof.

Particularly preferred pigment particles, especially platelet particles, include molybdenum sulfide, beta-phthalocyanine, fluororubine, red perylenes, diketopyrrolopyrroles, carbon black and graphite, wherein graphite platelets, such as Graphitan® (Ciba Specialty Chemicals), coated with titanium dioxide are especially preferred.

The size of the particles is not critical per se and can be adapted to the particular use. The pigment particles may be suspended in the aqueous solution of a fluorine scavenger via stirring or other forms of agitation. Said fluorine scavenger is preferably any compound that can scavenge fluorine ion in aqueous solution such as boric acid, sodium borate, ammonium borate, boron anhydride, boron monoxide, preferably boric acid. In one embodiment of the invention, boric acid is used. The concentration of the boric acid solution is at least that which is required to scavenge fluoride ion during the deposition of the metal oxide coating on the pigment particle. In one embodiment an excess of the boric acid is used as it may be removed by washing with water. Typically the boric acid is used in the range of about 0.01˜0.5 M, preferably about 0.04˜0.1 M, based upon the total amount of aqueous solution. The temperature of the boric acid solution is between the freezing point and the boiling point of the circulating media without the application of pressure. The process can be conveniently carried out between about 15° C. and about 95° C. With back pressure regulator equipped the temperature can also be set above the boiling point of the circulating media when the pressure of the reaction vessel is properly set.

The oxides of elements of the groups 3 to 15 of the periodic table are deposited on the pigment particle in the process of the present invention by adding an aqueous solution of a fluorine containing metal complex which is a precursor of the desired metal oxide and applying microwave energy. Generally, the solution is added continuously to the suspended pigment particle in order to limit the precipitation of the metal oxide rather than deposition onto the pigment particle. The metal oxides that are suitable for coating the substrate material and subsequent layers of metal oxide are well known in the art and include TiO₂, ZrO₂, CoO, SiO₂, SnO₂, GeO₂, ZnO, Al₂O₃, V₂O₅, Fe₂O₃, Cr₂O₃, PbTiO₃, CuO, or a mixture thereof. Particular preference is (are) given to titanium dioxide, iron, oxide and silicon dioxide. The precursor solution that forms the desired metal oxide is preferably a solution of one or a combination of the following material:
(a) soluble metal fluoride salt,
(b) soluble metal fluorine complex,
(c) any mixture that forms said salt or complex.

Examples include ammonium hexafluorotitanate; ammonium hexafluorostanate; ammonium hexafluorosilicate; iron(III) chloride, hydrofluoric acid and ammonium fluoride mixture; aluminum(III) chloride, hydrofluoric acid, and ammonium fluoride mixtures; ammonium hexafluorogermanate; combination of indium(III) fluoride trihydrate and ammonium hexafluorostanate. In the last example metal oxide layers are formed comprising more than one metal oxide, i.e. an indium tin oxide layer. The concentration of the fluorine containing metal complex is not critical to the process and is dictated by what is easy to handle because the mixture can be irradiated until the desired thickness is obtained. Thus, the concentration may range from about 0.01 M up to a saturated solution. In one embodiment of the invention a range of about 0.1 M to about 0.2 M is used, based upon the total amount of aqueous solution.

The thickness of the layers is not critical per se and will in general range from 1 to 500 nm.

Any available microwave sources can be used. Furthermore, the frequency of the microwave, if the source is adjustable, can be tuned to promote deposition of metal oxide onto the surface. A presently preferred microwave oven is a laboratory modified Panasonic NN-S542 with 2,450 MHz operating frequency and 1,300 W power output.

Once the addition of the fluorine containing metal complex is completed and the desired metal oxide layer thickness is achieved, the suspension can be filtered and washed with deionized water, dried and, optionally, calcined at a temperature of about 100 to 900° C. A non-oxidizing atmosphere, or under vacuum lower than 1 Pa is preferred, when the metal involved is at metastable valence. The calcination temperature must be lower than the decomposition temperature of the substrate.

Optionally, the pigment particles can be provided with an additional, outermost semi-transparent light absorbing metal oxide layer formed of, for example, Fe₂O₃, CoO, CoTiO₃, Cr₂O₃, Fe₂TiO₅, or a silicon suboxide SiOₓ, wherein x is less than one and preferably about 0.2. Said light absorbing metal oxide layer absorbs at least a portion of all but certain wavelengths of light to provide an enhanced impression of the selected color. The SiOₓ layer may be formed by known methods, for example, by thermally decomposing SiH₄ in the presence of the coated cores, in a fluidized bed reactor. The presence of the additional light absorbing layer can increase both the chroma and the color shift optical variance of the pigment. The additional light absorbing layer should have a thickness of 5 to 50 nm, preferably 5 to 30 nm. The pigments formed in accordance with the present invention may be further subjected to post treatment (surface modification) using any conventionally known method to improve the weatherability, dispersibility and/or water stability of a pigment. The pigments of the present invention are suitable for use in imparting color to high molecular weight (10³ to 10⁸ g/mol) organic materials (plastics), glass, ceramic products, cosmetic compositions, ink compositions and especially coating compositions and paints.

The pigments of the present invention may also be used to advantage for such purposes in admixture with transparent and hiding white, colored and black pigments, carbon black and transparent, colored and black luster pigments (i.e., those based on metal oxide coated mica), and metal pigments, including goniochromatic interference pigments based on metallic or non-metallic core materials, platelet-shaped iron oxides, graphite, molybdenum sulfide and platelet-shaped organic pigments. The coloristic properties of the present pigments may also be altered by reacting said pigments in hydrogen, carbon monoxide, ammonia or a combination thereof to form a surface layer of reduced metal (for example Fe or Ti) oxide or nitride, which surface layer will cause the darkening of the pigment color.

In a further embodiment, the present invention relates to a process for the preparation of optically variable pigments exhibiting an optical goniochromatic effect (effect pigments) using microwave deposition of a metal oxide from an aqueous suspension of precursor material onto a core material.

The process for the preparation of the effect pigment comprising a core material and at least one dielectric layer consisting of one or more oxides of a metal selected from the group 3 to 15 of the periodic table, comprises the steps of:
(a) suspending the core material in an aqueous solution of a fluorine scavenger;
(b) adding an aqueous solution of one or more fluorine containing metal complexes which are the precursors of the desired metal oxide coating; and
(c) subjecting said suspension to microwave radiation to deposit the metal oxide onto said core material.

Steps (b) and (c) can optionally be repeated using different fluorine containing metal complexes to produce one or more metal oxide layers or a gradient of concentration of 2 different metal oxides across the thickness.

These layers may alter the optical goniochromatic properties because of their different refractive indices, or affect other properties, such as, to catalyze the formation of certain morphology, or suppress photoactivity.

Preferably, the fluorine containing metal complex is added continuously to the suspension of core material in the aqueous solution of fluorine scavenger.

Effect pigments are metallic or non-metallic, inorganic platelet-shaped particles or pigments (especially metal effect pigments or interference pigments), that is to say, pigments that, besides imparting color to an application medium, impart additional properties, for example angle dependency of the color (flop), lustre (not surface gloss) or texture. On metal effect pigments, substantially oriented reflection occurs at directionally oriented pigment particles. In the case of interference pigments, the color-imparting effect is due to the phenomenon of interference of light in thin, highly refractive layers.

As metallic substrates, in principal, all metals can be used which are stable under the employed reaction conditions. Examples of a metallic platelet-shaped core material are titanium, silver, aluminum, copper, chromium, iron, germanium, molybdenum, tantalum, or nickel. The metals, for example aluminum, can optionally be coated with a protective layer, for example silicon dioxide, before being coated by the inventive process (EP-A-708155), wherein for example, effect pigments having the following layer structure are obtained: Al (reflective core); SiO₂ (thickness: 250 to 700 nm), Fe₂O₃ (thickness: 10 to 40 nm).

The metallic substrates can be used to prepare metal effect pigments, wherein the thickness of the dielectric layer(s) is chosen so that they do not substantially affect the color properties of the reflector layer.

Preferred interference pigments on the basis of metallic substrates, which can be prepared by the process of the present invention, have the following layer structure: thin, semi-opaque metal layer (chromium, nickel)/dielectric layer (SiO₂, MgF₂, Al₂O₃)/reflecting metal layer (aluminium)/dielectric layer/thin, semi-opaque metal layer, especially chromium/SiO₂/aluminium/SiO₂/chromium and chromium/MgF₂/aluminium/MgF₂/chromium (U.S. Pat. No. 5,059,245); TM′TMTM′T or TM′TM′T, wherein M′ is a semi-transparent metal layer, especially an aluminium or aluminium-based metal layer, T is a transparent dielectric of low refractive index and M is a highly reflective opaque aluminium or aluminium-based layer, especially SiO₂/Al/SiO₂/Al/SiO₂ and SiO₂/Al/SiO₂/Al/SiO₂/Al/SiO₂ (U.S. Pat. No. 3,438,796).

The metal layer can be obtained by wet chemical coating or by chemical vapor deposition, for example, gas phase deposition of metal carbonyls. The substrate is suspended in an aqueous and/or organic solvent containing medium in the presence of a metal compound and is deposited onto the substrate by addition of a reducing agent. The metal compound is, for example, silver nitrate or nickel acetyl acetonate (WO03/37993).

According to U.S. Pat. No. 3,536,520 nickel chloride can be used as metal compound and hypophosphite can be used as reducing agent. According to EP-A-353544 the following compounds can be used as reducing agents for the wet chemical coating: aldehydes (formaldehyde, acetaldehyde, benzalaldehyde), ketones (acetone), carbonic acids and salts thereof (tartaric acid, ascorbinic acid), reductones (isoascorbinic acid, triosereductone, reductine acid), and reducing sugars (glucose).

If semi-transparent metal layers are desired, the thickness of the metal layer is generally between 5 and 25 nm, especially between 5 and 15 nm.

Examples of non-metallic, inorganic platelet-shaped core materials are described in Chem. Rev. 1999, 99, 1963-1981 and are, for example, mica, another layered silicate, Al₂O₃ as in EP-A-763 573, iron oxide, titanium dioxide, as in U.S. Provisional Application Nos. 60/479,011 and 60/515,015, aluminum silicate (obtained heating of SiO_{z}/Al/SiO_{z} with 0.70≦z≦2.0 in an oxygen-free atmosphere; PCT/EP03/50777 and U.S. Pat. No. 6,013,370), materials on the basis of silicon oxides, such as silicon dioxide (SiO₂; WO93/08237, WO03/068868), SiO₂/SiOₓ/SiO₂, SiO_{1.40-2.0}/SiO_{0.70-0.99}/SiO_{1.40-2.0} (0.03≦x≦0.95; WO03/076520), Si/SiO_{z} (0.70≦z≦2.0, WO03/106569), SiO_{z} (0.70≦z≦2.0; especially 1.40≦z≦2.0; PCT/EP03/11077), wherein the material can optionally be porous (PCT/EP04/000137), such as for example porous SiO₂.

The term “SiO_{z} with 0.70≦z≦2.0” means that the molar ratio of oxygen to silicon at the average value of the silicon oxide layer is from 0.70 to 2.0. The composition of the silicon oxide layer can be determined by ESCA (electron spectroscopy for chemical analysis). SiO_{y} and SiOₓ are defined accordingly.

The present invention is illustrated in more detail on the basis of SiO_{z} flakes with 1.4≦z≦2.0 as core material, but is not limited thereto.

The SiO_{z} core particles generally have a length of from 2 μm to 5 mm, a width of from 2 μm to 2 mm, and a thickness of from 20 nm to 2 μm, and a ratio of length to thickness of at least 2:1 and two substantially parallel faces, the distance between which is the shortest axis of the core, wherein 1.4≦y≦2.0.

Effect pigments manufactured according to the process of the present invention comprise in said embodiment a core material of SiO_{z} and at least one dielectric layer consisting of one or more oxides of a metal selected from the group 3 to 15 of the periodic table.

Preferred interference pigments comprise (a) a metal oxide of high refractive index, such as Fe₂O₃, or TiO₂, and (b) a metal oxide of low refractive index, such as SiO₂, wherein the difference of the refractive indices is at least 0.1: TiO₂ (substrate: silicon oxide; layer: TiO₂), (SnO₂)TiO₂, Fe₂O₃, Sn(Sb)O₂, Fe₂O₃.TiO₂ (substrate: silicon oxide; mixed layer of Fe₂O₃ and TiO₂), TiO₂/Fe₂O₃ (substrate: silicon oxide; first layer: TiO₂; second layer: Fe₂O₃). In general the layer thickness ranges from 1 to 1000 nm, preferably from 1 to 300 nm.

Another particularly preferred embodiment relates to interference pigments containing at least three alternating layers of high and low refractive index, such as, for example, TiO₂/SiO₂/TiO₂, (SnO₂)TiO₂/SiO₂/TiO₂, TiO₂/SiO₂/TiO₂/SiO₂/TiO₂ or TiO₂/SiO₂/Fe₂O₃:

Preferably the layer structure is as follows:

(A) a coating having a refractive index >1.65,
(B) a coating having a refractive index ≦1.65,
(C) a coating having a refractive index >1.65, and
(D) optionally an outer protective layer.

Examples of a dielectric material having a “high” refractive index, that is to say a refractive index greater than about 1.65, preferably greater than about 2.0, most preferably greater than about 2.2, are zinc sulfide (ZnS), zinc oxide (ZnO), zirconium oxide (ZrO₂), titanium dioxide (TiO₂), carbon, indium oxide (In₂O₃), indium tin oxide (ITO), tantalum pentoxide (Ta₂O₅), chromium oxide (Cr₂O₃), cerium oxide (CeO₂), yttrium oxide (Y₂O₃), europium oxide (Eu₂O₃), iron oxides such as iron(II)/iron(III) oxide (Fe₃O₄) and iron(III) oxide (Fe₂O₃), hafnium nitride (HfN), hafnium carbide (HfC), hafnium oxide (HfO₂), lanthanum oxide (La₂O₃), magnesium oxide (MgO), neodymium oxide (Nd₂O₃), praseodymium oxide (Pr₆O₁₁), samarium oxide (Sm₂O₃), antimony trioxide (Sb₂O₃), silicon monoxides (SiO), selenium trioxide (Se₂O₃), tin oxide (SnO₂), tungsten trioxide (WO₃) or combinations thereof. The dielectric material is preferably a metal oxide. It is possible for the metal oxide to be a single oxide or a mixture of oxides, with or without absorbing properties, for example, TiO₂, ZrO₂, Fe₂O₃, Fe₃O₄, Cr₂O₃ or ZnO, with TiO₂ being especially preferred.

Nonlimiting examples of suitable low index dielectric materials that can be used include silicon dioxide (SiO₂), aluminum oxide (Al₂O₃), and metal fluorides such as magnesium fluoride (MgF₂), aluminum fluoride (AlF₃), cerium fluoride (CeF₃), lanthanum fluoride (LaF₃), sodium aluminum fluorides (e.g., Na₃AlF₆ or Na₅Al₃F₁₄), neodymium fluoride (NdF₃), samarium fluoride (SmF₃), barium fluoride (BaF₂), calcium fluoride (CaF₂), lithium fluoride (LiF), combinations thereof, or any other low index material having an index of refraction of about 1.65 or less. For example, organic monomers and polymers can be utilized as low index materials, including dienes or alkenes such as acrylates (e.g., methacrylate), polymers of perfluoroalkenes, polytetrafluoroethylene (TEFLON), polymers of fluorinated ethylene propylene (FEP), parylene, p-xylene, combinations thereof, and the like. Additionally, the foregoing materials include evaporated, condensed and cross-linked transparent acrylate layers, which may be deposited by methods described in U.S. Pat. No. 5,877,895, the disclosure of which is incorporated herein by reference.

The thickness of the individual layers of high and low refractive index on the base substrate is essential for the optical properties of the pigment. The thickness of the individual layers, especially metal oxide layers, depends on the field of use and is generally 10 to 1000 nm, preferably 15 to 800 nm, in particular 20 to 600 nm.

The thickness of layer (A) is 10 to 550 nm, preferably 15 to 400 nm and, in particular, 20 to 350 nm. The thickness of layer (B) is 10 to 1000 nm, preferably 20 to 800 nm and, in particular, 30 to 600 nm. The thickness of layer (C) is 10 to 550 nm, preferably 15 to 400 nm and, in particular, 20 to 350 nm.

Particularly suitable materials for layer (A) are metal oxides, or metal oxide mixtures, such as TiO₂, Fe₂O₃, Sn(Sb)O₂, SnO₂, titanium suboxides (reduced titanium species having oxidation states from 2 to <4), and also mixtures or mixed phases of these compounds with one another or with other metal oxides.

Particularly suitable materials for layer (B) are metal oxides or the corresponding oxide hydrates, such as SiO₂.

Particularly suitable materials for layer (C) are colorless or colored metal oxides, such as TiO₂, Fe₂O₃, Sn(Sb)O₂, SnO₂, titanium suboxides (reduced titanium species having oxidation states from 2 to <4), and also mixtures or mixed phases of these compounds with one another or with other metal oxides. The TiO₂ layers can additionally contain an absorbing material, such as carbon, selectively absorbing colorants, selectively absorbing metal cations, can be coated with absorbing material, or can be partially reduced.

Interlayers of absorbing or nonabsorbing materials can be present between layers (A), (B), (C) and (D). The thickness of the interlayers is 1 to 50 nm, preferably 1 to 40 nm and, in particular, 1 to 30 nm.

In this embodiment preferred interference pigments have the following layer structure:

| | | | |
|---|---|---|---|
| SiO_{z} | TiO₂ | SiO₂ | TiO₂ |
| SiO_{z} | TiO₂ | SiO₂ | Fe₂O₃ |
| SiO_{z} | TiO₂ | SiO₂ | TiO₂/Fe₂O₃ |
| SiO_{z} | TiO₂ | SiO₂ | (Sn,Sb)O₂ |
| SiO_{z} | (Sn,Sb)O₂ | SiO₂ | TiO₂ |
| SiO_{z} | Fe₂O₃ | SiO₂ | (Sn,Sb)O₂ |
| SiO_{z} | TiO₂/Fe₂O₃ | SiO₂ | TiO₂/Fe₂O₃ |
| SiO_{z} | Cr₂O₃ | SiO₂ | TiO₂ |
| SiO_{z} | Fe₂O₃ | SiO₂ | TiO₂ |
| SiO_{z} | TiO suboxides | SiO₂ | TiO suboxides |
| SiO_{z} | TiO₂ | SiO₂ | TiO₂ + SiO₂ + TiO₂ |
| SiO_{z} | TiO₂ + SiO₂ + TiO₂ | SiO₂ | TiO₂ + SiO₂ + TiO₂ |

In said embodiment all layers of the interference pigments are preferably deposited by microwave deposition, but part of the layers can also be applied by CVD (chemical vapor deposition) or by wet chemical coating:

| | | | |
|---|---|---|---|
| SiO_{z} | TiO₂ | Al₂O₃ | TiO₂ |
| SiO_{z} | Fe₂TiO₅ | SiO₂ | TiO₂ |
| SiO_{z} | TiO₂ | SiO₂ | Fe₂TiO₅/TiO₂ |
| SiO_{z} | TiO₂ | SiO₂ | MoS₂ |
| SiO_{z} | TiO₂ | SiO₂ | Cr₂O₃ |
| SiO_{z} | TiO₂ | SiO₂ | TiO₂ + SiO₂ + TiO₂ + |
| | | | Prussian Blue |

The metal oxide layers can be applied by means of oxidative gaseous phase decomposition of metal carbonyls (e.g. iron pentacarbonyl, chromium hexacarbonyl; EP-A-45 851), by means of hydrolytic gaseous phase decomposition of metal alcoholates (e.g. titanium and zirconium tetra-n- and -iso-propanolate; DE-A-41 40 900) or of metal halides (e.g. titanium tetrachloride; EP-A-338 428), by means of oxidative decomposition of organyl tin compounds (especially alkyl tin compounds such as tetrabutyltin and tetramethyltin; DE-A-44 03 678) or by means of the gaseous phase hydrolysis of organyl silicon compounds (especially di-tert-butoxyacetoxysilane) described in EP-A-668 329, it being possible for the coating operation to be carried out in a fluidised-bed reactor (EP-A-045 851 and EP-A-106 235). Layers of oxides of the metals zirconium, titanium, iron and zinc, oxide hydrates of those metals, iron titanates, titanium suboxides or mixtures thereof can be applied by precipitation by a wet chemical method, it being possible, where appropriate, for the metal oxides to be reduced. In the case of the wet chemical coating, the wet chemical coating methods developed for the production of pearlescent pigments may be used; these are described, for example, in DE-A-14 67 468, DE-A-19 59 988, DE-A-20 09 566, DE-A-22 14 545, DE-A-22 15 191, DE-A-22 44 298, DE-A-23 13 331, DE-A-25 22 572, DE-A-31 37 808, DE-A-31 37 809, DE-A-31 51 343, DE-A-31 51 354, DE-A-31 51 355, DE-A-32 11 602 and DE-A-32 35 017, DE 195 99 88, EP-A-892832, EP-A-753545, EP-A-1213330, WO93/08237, WO98/53001, WO98/12266, WO98/38254, WO99/20695, WO00/42111 and WO03/6558.

The metal oxide of high refractive index is preferably TiO₂ and/or iron oxide, and the metal oxide of low refractive index is preferably SiO₂. Layers of TiO₂ can be in the rutile or anastase modification, wherein the rutile modification is preferred. TiO₂ layers can also be reduced by known means, for example ammonia, hydrogen, hydrocarbon vapor or mixtures thereof, or metal powders, as described in EP-A-735114, DE-A-3433657, DE-A-4125134, EP-A-332071, EP-A-707050 or WO93/19131.

As described in PCT/EP03/50690, TiO₂-coated SiO_{y} platelets, wherein 0.03≦y≦1.95 are first calcined in a non-oxidizing gas atmosphere at a temperature of more than 600° C. and then optionally treated, where appropriate, at a temperature of more than 200° C., preferably more than 400° C. and especially from 500 to 1000° C., with air or another oxygen-containing gas.

In a particularly preferred embodiment the present invention is directed to SiO_{z} with 1.40≦z≦2.0 or SiO₂ flakes having a thickness of 70 to 130 nm, comprising a titanium dioxide layer having a thickness of 60 nm to 120 nm.

The SiO_{z} with 1.40≦z<2.0 or SiO₂ flakes are not of a uniform shape. Nevertheless, for purposes of brevity, the flakes will be referred to as having a “diameter.” The silicon oxide flakes have a high plane-parallelism and a defined thickness in the range of ±10%, especially ±5% of the average thickness of the diameter. The SiO_{z} with 1.40≦z≦2.0 or SiO₂ flakes have a thickness of from 70 to 100 nm, especially from 90 to 110 nm, very especially about 100 nm. It is presently preferred that the diameter of the flakes be in a preferred range of about 1-60 μm with a more preferred range of about 5-40 μm. Thus, the aspect ratio of the flakes of the present invention is in a preferred range of about 7 to 860 with a more preferred range of about 38 to 572.

The titanium dioxide layer is preferably deposited by microwave deposition, but can, in principal, as described above also be applied by CVD (chemical vapor deposition) or by wet chemical coating.

Hence, the present invention is directed to SiO_{z} with 1.40≦z≦2.0 or SiO₂ flakes having a thickness of 70 to 130 nm, especially 90 to 110 nm, very especially about 100 nm, comprising a titanium dioxide layer having a thickness of 60 nm to 120 nm, obtainable by the process of the present invention.

The titanium dioxide layer has a thickness of 60 nm to 120 nm, especially 80 to 100 nm, very especially about 90 nm.

It is possible to obtain pigments that are more intense in color and more transparent by applying, on top of the TiO₂ layer, a metal oxide of “low” refractive index, that is to say a refractive index smaller than about 1.65, such as SiO₂, Al₂O₃, AlOOH, B₂O₃ or a mixture thereof, preferably SiO₂, and applying a further Fe₂O₃ and/or TiO₂ layer on top of the latter layer. Such multi-coated interference pigments comprising a silicon/silicon oxide substrate and alternating metal oxide layers of with high and low refractive index can be prepared in analogy to the processes described in WO98/53011 and WO99/20695, or preferably by using the process of the present invention.

Accordingly, in said embodiment the layer structure is as follows:

(A) a coating having a refractive index >1.65,
(B) a coating having a refractive index ≦1.65,
(C) optionally a coating having a refractive index >1.65, and
(D) optionally an outer protective layer.

The thickness of layer (B) is in the range of 70 to 130 nm, especially 90 to 110 nm, very especially about 100 nm. The thickness of layer (A) and (C) is in the range of 60 nm to 120 nm, especially 80 to 100 nm, very especially about 90 nm.

If the SiO_{z} with 1.40≦z<2.0 or SiO₂ flakes comprise (A) a coating having a refractive index >1.65, and (B) a coating having a refractive index ≦1.65, and layer (B) is employed as protective layer, the protective layer has a thickness of from 2 to 250 nm thick, especially from 10 to 100 nm.

A particularly preferred embodiment relates to interference pigments containing at least two alternating layers of high and low refractive index, such as, for example, TiO₂/SiO₂, TiO₂/SiO₂/TiO₂, (SnO₂)TiO₂/SiO₂/TiO₂, TiO₂/SiO₂/TiO₂/SiO₂/TiO₂ or TiO₂/SiO₂/Fe₂O₃.

It is furthermore possible to subject the finished pigment to subsequent coating or subsequent treatment which further increases the light, weather and chemical stability or which facilitates handling of the pigment, especially its incorporation into various media. For example, the procedures described in DE-A-22 15 191, DE-A-31 51 354, DE-A-32 35 017 or DE-A-33 34 598 are suitable as subsequent treatment or subsequent coating.

Where appropriate, an SiO₂ protective layer can be applied on top of the titanium dioxide layer, for which the following method may be used: A soda waterglass solution is metered in to a suspension of the material being coated, which suspension has been heated to about 50-100° C., especially 70-80° C. The pH is maintained at from 4 to 10, preferably from 6.5 to 8.5, by simultaneously adding 10% hydrochloric acid. After addition of the waterglass solution, stirring is carried out for 30 minutes.

The effect pigments on basis of SiO_{z} with 1.40≦z≦2.0 or SiO₂ flakes can be used for all customary purposes (see, for example, WO03/068868 and PCT/EP03/11077), for example for coloring polymers in the mass, coatings (including effect finishes, including those for the automotive sector) and printing inks (including offset printing, intaglio printing, bronzing and flexographic printing), and also, for example, for applications in cosmetics (see, for example, PCT/EP03/09269), in ink-jet printing (see, for example, PCT/EP03/50690), for dyeing textiles (see, for example, PCT/EP03/11188), glazes for ceramics and glass as well as laser marking of papers and plastics. Such applications are known from reference works, for example “Industrielle Organische Pigmente” (W. Herbst and K. Hunger, VCH Verlagsgesellschaft mbH, Weinheim/New York, 2nd, completely revised edition, 1995).

The effect pigments on basis of the SiO_{z} with 1.40≦z<2.0 or SiO₂ flakes can be used with excellent results for pigmenting high molecular weight organic material.

The high molecular weight organic material for the pigmenting of which the pigments or pigment compositions according to the invention may be used may be of natural or synthetic origin. High molecular weight organic materials usually have molecular weights of about from 10³ to 10⁸ g/mol or even more. They may be, for example, natural resins, drying oils, rubber or casein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerization, polycondensation or polyaddition. From the class of the polymerization resins there may be mentioned, especially, polyolefins, such as polyethylene, polypropylene or polyisobutylene, and also substituted polyolefins, such as polymerization products of vinyl chloride, vinyl acetate, styrene, acrylonitrile, acrylic acid esters, methacrylic acid esters or butadiene, and also copolymerisation products of the said monomers, such as especially ABS or EVA.

The effect pigments on basis of the SiO_{z} with 1.40≦z<2.0 or SiO₂ flakes can be added in any tinctorially effective amount to the high molecular weight organic material being pigmented. A pigmented substance composition comprising a high molecular weight organic material and from 0.01 to 80% by weight, preferably from 0.1 to 30% by weight, based on the high molecular weight organic material, of an pigment according to the invention is advantageous. Concentrations of from 1 to 20% by weight, especially of about 10% by weight, can often be used in practice.

The pigments of the invention can be used in plastics comprising the effect pigments on the basis of the SiO_{z} with 1.40≦z<2.0 or SiO₂ flakes in amounts of 0.1 to 50% by weight, in particular 0.5 to 7% by weight. In the coating sector, the pigments of the invention are employed in amounts of 0.1 to 10% by weight. In the pigmentation of binder systems, for example for paints and printing inks for intaglio, offset or screen printing, the pigment is incorporated into the printing ink in amounts of 0.1 to 50% by weight, preferably 5 to 30% by weight and in particular 8 to 15% by weight.

The effect pigments on the basis of SiO_{z} with 1.40≦z<2.0 or SiO₂ flakes are also suitable for making-up the lips or the skin and for coloring the hair or the nails.

The invention accordingly relates also to a cosmetic preparation or formulation comprising from 0.0001 to 90% by weight of a pigment, especially an effect pigment according to the invention and from 10 to 99.9999% of a cosmetically suitable carrier material, based on the total weight of the cosmetic preparation or formulation.

The colorations obtained, for example in plastics, coatings or printing inks, especially in coatings or printing inks, more especially in coatings, are distinguished by excellent properties, especially by extremely high saturation, outstanding fastness properties, high color purity and high goniochromicity.

Instead of SiO_{z} flakes very thin glass flakes having the following characteristics can be used:

(1) thickness of the glass flakes ≦1.0 um
(2) high temperature and mechanical stability
(3) smooth surfaces (WO02/090448).

Suitable glass flakes, preferably prepared according to EP-A-0289240, are characterized in that they contain an average particle size in the range of 1000 μm, preferably in the range of 5-150 μm. Preferred glass flakes have an average particle size in the range of 5-150 μm and a thickness of 0.1-0.5 μm, preferably of 0.1-0.3 μm. The aspect ratio of glass flakes is in the range of 10-300, preferably in the range of 50-200.

The SiO_{z} flakes are prepared by a process comprising the steps (WO03/68868):

a) vapor-deposition of a separating agent onto a (movable) carrier to produce a separating agent layer,
b) vapor-deposition of a SiO_{y} layer onto the separating agent layer, wherein 0.70≦y≦1.8,
c) dissolution of the separating agent layer in a solvent, and
d) separation of the SiO_{y} from the solvent.

SiO_{y} with y>1.0 can be obtained by evaporation of SiO in the presence of oxygen. Layers, which are essentially free of absorption, can be obtained if the growing SiO_{y} layer is irradiated with UV light during evaporation (DE-A-1621214). It is possible to obtain SiO_{1.5} layers, which do not absorb in the visible region and have a refractive index of 1.55 at 550 nm, by so-called “reactive evaporation” of SiO in a pure oxygen atmosphere (E. Ritter, J. Vac. Sci. Technol. 3 (1966) 225).

The SiO_{y} layer in step b) being vapor-deposited from a vaporizer containing a charge comprising a mixture of Si and SiO₂, SiO_{y} or a mixture thereof, the weight ratio of Si to SiO₂ being preferably in the range from 0.15:1 to 0.75:1, and especially containing a stoichiometric mixture of Si and SiO₂ or a vaporizer containing a charge comprising silicon monoxide containing silicon in an amount up to 20% by weight (0.70≦y<1.0). Step c) is advantageously carried out at a pressure that is higher than the pressure in steps a) and b) and lower than atmospheric pressure. The SiO_{y} flakes obtainable by this method have a thickness in the range preferably from 20 to 2000 nm, especially from 20 to 500 nm, most preferably from 50 to 350 nm, the ratio of the thickness to the surface area of the plane-parallel structures being preferably less than 0.01 μm⁻¹. The plane-parallel structures thereby produced are distinguished by high uniformity of thickness, a superior planarity and smoothness (surface microstructure).

The silicon oxide layer in step b) is formed preferably from silicon monoxide vapor produced in the vaporizer by reaction of a mixture of Si and SiO₂ at temperatures of more than 1300° C.

If, under industrial vacuums of a few 10⁻² Pa, Si is vaporized (instead of Si/SiO₂ or SiO/Si), silicon oxides can be obtained which have an oxygen content of less than 0.70, that is to say SiOₓ wherein 0.03≦x≦0.69, especially 0.05≦x≦0.50, very especially 0.10≦x≦0.30 (PCT/EP03/02196).

A SiO_{0.70-0.99} layer is formed by evaporating silicon monoxide-containing silicon in an amount up to 20% by weight at temperatures of more than 1300° C.

The vapor-deposition in steps a) and b) is carried out preferably under a vacuum of <0.5 Pa. The dissolution of the separating agent layer in step c) is carried out at a pressure in the range preferably from 1 to 5×10⁴ Pa, especially from 600 to 10⁴ Pa, and more especially from 10³ to 5×10³ Pa.

The separating agent vapor-deposited onto the carrier in step a) may be a lacquer (coating), a polymer, such as, for example, the (thermoplastic) polymers, in particular acrylic or styrene polymers or mixtures thereof, as described in U.S. Pat. No. 6,398,999, an organic substance soluble in organic solvents or water and vaporizable in vacuo, such as anthracene, anthraquinone, acetamidophenol, acetylsalicylic acid, camphoric anhydride, benzimidazole, benzene-1,2,4-tricarboxylic acid, biphenyl-2,2-dicarboxylic acid, bis(4-hydroxyphenyl)sulfone, dihydroxyanthraquinone, hydantoin, 3-hydroxybenzoic acid, 8-hydroxyquinoline-5-sulfonic acid monohydrate, 4-hydroxycoumarin, 7-hydroxycoumarin, 3-hydroxynaphthalene-2-carboxylic acid, isophthalic acid, 4,4-methylene-bis-3-hydroxynaphthalene-2-carboxylic acid, naphthalene-1,8-dicarboxylic anhydride, phthalimide and its potassium salt, phenolphthalein, phenothiazine, saccharin and its salts, tetraphenylmethane, triphenylene, triphenylmethanol or a mixture of at least two of those substances. The separating agent is preferably an inorganic salt soluble in water and vaporizable in vacuo (see, for example, DE 198 44 357), such as sodium chloride, potassium chloride, lithium chloride, sodium fluoride, potassium fluoride, lithium fluoride, calcium fluoride, sodium aluminium fluoride, disodium tetraborate or mixtures thereof.

The movable carrier may consist of one or more discs, cylinders or other rotationally symmetrical bodies, which rotate about an axis (cf. WO01/25500), and consists preferably of one or more continuous metal belts with or without a polymeric coating or of one or more polyimide or polyethylene terephthalate belts (U.S. Pat. No. 6,270,840).

Step d) may comprise washing-out and subsequent filtration, sedimentation, centrifugation, decanting and/or evaporation. The plane-parallel structures of SiO_{y} may, however, also be frozen together with the solvent in step d) and subsequently subjected to a process of freeze-drying, whereupon the solvent is separated off as a result of sublimation below the triple point and the dry SiO_{y} remains behind in the form of individual plane-parallel structures.

Except under an ultra-high vacuum, in technical vacuums of a few 10⁻² Pa vaporized SiO always condenses as SiO_{y} wherein 1≦y≦1.8, especially wherein 1.1≦y≦1.8, because high-vacuum apparatuses always contain, as a result of gas emission from surfaces, traces of water vapor which react with the readily reactive SiO at vaporization temperature.

On its further course, the belt-form carrier, which is closed to form a loop, runs through dynamic vacuum lock chambers of known mode of construction (cf. U.S. Pat. No. 6,270,840) into a region of from 1 to 5×10⁴ Pa pressure, preferably from 600 to 10⁴ Pa pressure, and especially from 10³ to 5×10³ Pa pressure, where it is immersed in a dissolution bath. The temperature of the solvent should be so selected that its vapor pressure is in the indicated pressure range. With mechanical assistance, the separating agent layer rapidly dissolves and the product layer breaks up into flakes, which are then present in the solvent in the form of a suspension. On its further course, the belt is dried and freed from any contaminants still adhering to it. It runs through a second group of dynamic vacuum lock chambers back into the vaporization chamber, where the process of coating with separating agent and product layer of SiO is repeated.

The suspension then present in both cases, comprising product structures and solvent, and the separating agent dissolved therein, is then separated in a further operation in accordance with a known technique. For that purpose, the product structures are first concentrated in the liquid and rinsed several times with fresh solvent in order to wash out the dissolved separating agent. The product, in the form of a solid that is still wet, is then separated off by filtration, sedimentation, centrifugation, decanting or evaporation.

The product can then be brought to the desired particle size by means of ultrasound or by mechanical means using high-speed stirrers in a liquid medium, or after drying the fragments in an air-jet mill having a rotary classifier, or means of grinding or air-sieving

The SiO_{y} flakes may be oxidized using an oxygen-containing gas such as, for example, air at a temperature of at least 200° C., especially at above 400° C., preferably in the form of loose material, in a fluidized bed or by introduction into an oxidizing flame, preferably at a temperature in the range from 500 to 1000° C., to form plane-parallel structures of SiO_{z} (WO03/068868).

The obtained SiO_{z} flakes are not of a uniform shape. Nevertheless, for purposes of brevity, the flakes will be referred to as having a “diameter.” The SiO_{y} flakes have a high plane-parallelism and a defined thickness in the range of ±10%, especially ±5% of the average thickness. The SiO_{z} flakes have a thickness of from 20 to 2000 nm, especially from 20 to 500 nm, most preferably 50 to 350 nm. It is presently preferred that the diameter of the flakes be in a preferred range of about 1-60 μm with a more preferred range of about 5-40 μm. Thus, the aspect ratio of the flakes is in a preferred range of about 2 to 3000 with a more preferred range of about 14 to 800. If a TiO₂ layer is deposited as a material of high refractive index, the TiO₂ layer has a thickness of 20 to 200 nm, especially 20 to 100 nm, and more especially 20 to 50 nm. Due to the smaller thickness distribution of the SiO flakes as compared to commercially available SiO₂ flakes, effect pigments having having superior brilliance, clear and intense colors, intense color flop, improved color strength and color purity can be obtained.

In another aspect, the present invention is directed to highly lustrous pearl lustre titanium dioxide-containing pigments. Such a pearl lustre pigment has a multilayer structure, where, on a core of platelet shaped titanium dioxide, there follows a layer of another metal oxide or metal oxide hydrate. Examples of other metal oxides or metal oxide hydrates which are applied to the titanium dioxide are Fe₂O₃, Fe₃O₄, FeOOH, Cr₂O₃, CuO, Ce₂O₃, Al₂O₃, SiO₂, BiVO₄, NiTiO₃, CoTiO₃ and also antimony-doped, fluorine-doped or indium-doped tin oxide. In a particular embodiment of the novel pigment, on the 1^{st} layer of another metal oxide or metal oxide hydrate is additionally present a 2^{nd} layer of a further metal oxide or metal oxide hydrate. This further metal oxide or metal oxide hydrate is aluminium oxide or aluminium oxide hydrate, silicon dioxide or silicon dioxide hydrate, Fe₂O₃, Fe₃O₄, FeOOH, TiO₂, ZrO₂, Cr₂O₃ as well as antimony-doped, fluorine-doped or indium-doped tin oxide, wherein the metal oxide of the first layer is different from that of the second layer.

These titanium dioxide platelets have a thickness of between 10 nm and 500 nm, preferably between 40 and 150 nm. The extent in the two other dimensions is between 2 and 200 μm and in particular between 5 and 50 μm.

The layer of another metal oxide which is applied to the titanium dioxide platelets has a thickness of 5 to 300 nm, preferably between 5 and 150 nm.

The titanium dioxide platelets are, for example, available according to a process described in WO98/53010 and U.S. Provisional Application 60/479,011 and 60/515,015.

Additionally, the coating of the titanium dioxide platelets, after drying in between, can also be carried out with metal oxides or metal oxide hydrates, for example, in a fluidized bed reactor by means of gas-phase coating, it being possible, for example, to use the processes for the preparation of pearl lustre pigments proposed in EP 0,045,851 and EP 0,106,235.

While it is preferred that all metal oxide layers are deposited using microwave radiation, part of the metal oxides can be deposited by conventional wet chemical methods: When coating with haematite (Fe₂O₃), the starting materials can be either iron(III) salts, as is described, for example, in U.S. Pat. No. 3,987,828 and U.S. Pat. No. 3,087,829, or iron(II) salts, as described in U.S. Pat. No. 3,874,890, the initially formed coating of iron(II) hydroxide being oxidized to iron(III) oxide hydrate. Iron(III) salts are preferably used as starting materials.

Coating with magnetite (Fe₃O₄) is carried out by hydrolysis of an iron(II) salt solution, for example, iron(II) sulphate, at a pH of 8.0 in the presence of potassium nitrate. The particular precipitation examples are described in EP-A-0659843.

For better adhesion of the iron oxide layers to the titanium dioxide platelets it is expedient to apply a tin oxide layer first.

Another metal oxide which is preferably deposited on the titanium dioxide platelets is chromium oxide. The deposition can easily be effected by means of thermal hydrolysis, which occurs in the volatilization of ammonia from an aqueous solution of a hexaminechromium(III) derivative, or by thermal hydrolysis of a chromium salt solution which is buffered with borax. Coating with chromium oxide is described in U.S. Pat. No. 3,087,828 and U.S. Pat. No. 3,087,829.

The pigments do not have to be calcined in every case. For certain applications drying at temperatures of 110° C. is sufficient. If the pigment is calcined, temperatures between 400° C. and 1000° C. can be used, the preferred range being between 400° C. and 700° C.

It is additionally possible to subject the pigments to an aftercoating or aftertreatment which further increases the light stability, weathering resistance and chemical stability or facilitates the handling of the pigment, especially its incorporation into different media. Examples of suitable aftercoating techniques are those described, for example, in DE-C 22 15 191, DE-A 31 51 354, DE-A 32 35 017 or DE-A 33 34 598. Owing to the fact that the properties of the novel pigments are already very good without these additional measures, these optional additionally applied substances make up only from about 0 to 5% by weight, in particular from about 0 to 3% by weight, of the overall pigment.

The iron oxide platelets are, for example, available according to a process described in U.S. Provisional Application 60/479,011 and 60/515,015. In detail, polymethyl methacrylate (PMMA) flakes are produced by adding a solution of polymethyl methacrylate in toluene/acetone to a glass tube that has one end sealed, connecting the tube to 20 torr vacuum and rotating it horizontally, whereby a coating of PMMA forms on the interior wall, rinsing off the PMMA off with deionized water and collecting the PMMA flakes by filtration. Then the PMMA flakes are coated with iron oxide by microwave deposition using FeCl₃.4NH₄F and boric acid. The obtained iron oxide coated PMMA flakes are collected by filtration and dried in a vacuum oven. The PMMA is dissolved in toluene by heating, and after sedimentation, filtration, washing and drying iron oxide flakes are obtained, which can be used for producing effect pigments.

Goniochromatic luster pigments based on multiply coated iron oxide platelets comprise at least one layer packet comprising

A) a colorless coating having a refractive index n≦1.8, and
B) a colorless coating having a refractive index ≧2.0.

The size of the iron oxide platelets is not critical per se and can be adapted to the particular application intended. In general, the platelets have mean largest diameters from about 1 to 50 μm, preferably from 5 to 20 μm. The thickness of the platelets is generally within the range from 10 to 500 nm.

The colorless low refractive coating (A) has a refractive index n≦1.8, preferably n≦1.6. Examples of such materials are given below. Particularly suitable materials include for example metal oxides and metal oxide hydrates such as silicon oxide, silicon oxide hydrate, aluminum oxide, aluminum oxide hydrate and mixtures thereof, preference being given to silicon oxide (hydrate).

The layer thickness of the coating (A) is generally within the range from 50 to 800 nm, preferably within the range from 100 to 600 nm. Since the layer (A) essentially determines the interference colors of the pigments, it has a minimum layer thickness of about 200 nm for luster pigments which have just one layer packet (A)+(B) and which exhibit a particularly pronounced color play and hence are also preferred. If a plurality (e.g., 2, 3 or 4) of layer packets (A)+(B) are present, the layer thickness of (A) is preferably within the range from 50 to 200 nm.

The colorless high refractive coating (B) has a refractive index n≧2.0, especially n≧2.4. Examples of such materials are given below. Particularly suitable layer materials (B) include not only metal sulfides such as zinc sulfide but especially metal oxides and metal oxide hydrates, for example titanium dioxide, titanium oxide hydrate, zirconium dioxide, zirconium oxide hydrate, tin dioxide, tin oxide hydrate, zinc oxide, zinc oxide hydrate and mixtures thereof, preference being given to titanium dioxide and titanium oxide hydrate and their mixtures with up to about 5% by weight of the other metal oxides, especially tin dioxide.

The coating (B) preferably has a smaller layer thickness than the coating (A). Preferred layer thicknesses for coating (B) range from about 5 to 50 nm, especially from 10 to 40 nm.

The coating (B), which is preferred according to the present invention, consists essentially of titanium dioxide.

In said embodiment all layers of the interference pigments are preferably deposited by microwave deposition, but part of the layers can also be applied by CVD (chemical vapor deposition) or by wet chemical coating:

The core material of the effect pigments may be suspended in the aqueous solution of a fluorine scavenger via stirring or other forms of agitation. Said fluorine scavenger is preferably any compound that can scavenge fluorine ion in aqueous solution such as boric acid, sodium borate, ammonium borate, boron anhydride, boron monoxide, particularly preferably boric acid. In one embodiment of the invention, boric acid is used. The concentration of the boric acid solution is at least that which is required to scavange fluoride ion during the deposition of the metal oxide coating on the core material. In one embodiment an excess of the boric acid is used as it may be removed by washing with water. Typically the boric acid is used in the range of about 0.01˜0.5 M, preferably about 0.04˜0.1 M. The temperature of the boric acid solution is between the freezing point and the boiling point of the circulating media without the application of pressure. The process can be conveniently carried out between about 15° C. and about 95° C. With back pressure regulator equipped the temperature can also be set above the boiling point of the circulating media when the pressure of the reaction vessel is properly set.

The oxides of elements of the groups 3 to 15 of the periodic table are deposited on the core material in the process of the present invention by adding an aqueous solution of a fluorine containing metal complex which is a precursor of the desired metal oxide and applying microwave energy. Generally, the aqueous solution is added continuously to the suspended core material in order to limit the precipitation of the metal oxide rather than deposition onto the pigment particle. The metal oxides that are suitable for coating the substrate material and subsequent layers of metal oxide are well known in the art and include TiO₂, ZrO₂, CoO, SiO₂, SnO₂, GeO₂, ZnO, Al₂O₃, V₂O₅, Fe₂O₃, Cr₂O₃, PbTiO₃ or CuO or a mixture thereof. Particular preference is given to titanium dioxide.

The precursor solution that forms the desired metal oxide is preferably an aqueous solution of one or a combination of the following material:

(a) soluble metal fluoride salt,
(b) soluble metal fluorine complex, or
(c) any mixture that forms said salt or complex.

Examples include ammonium hexafluorotitanate; ammonium hexafluorostanate; ammonium hexafluorosilicate; iron(III) chloride, hydrofluoric acid and ammonium fluoride mixture; aluminum(III) chloride, hydrofluoric acid, and ammonium fluoride mixtures; ammonium hexafluorogermanate; combination of indium(III) fluoride trihydrate and ammonium hexafluorostanate. In the last example metal oxide layers are formed comprising more than one metal oxide, i.e. an indium tin oxide layer. The concentration of the fluorine containing metal complex is not critical to the process and is dictated by what is easy to handle because the mixture can be irradiated until the desired thickness is obtained. Thus, the concentration may range from about 0.01 M up to a saturated solution. In one embodiment of the invention a range of about 0.1 M to about 0.2 M is used, based upon the total amount of aqueous solution.

For producing a mixed interference/absorption effect pigment, the metal oxide layer of dielectric material is preferably a colored (selectively absorbing, not gray or black) oxide or colored mixed oxide of elements of groups 5 to 12. A most preferred metal oxide layer comprises Fe₂O₃.

For producing a pure interference pigment, the metal oxide layer is preferably a substantially colorless oxide of an element of groups 3 or 4. A most preferred metal oxide layer comprises TiO₂.

The thickness of the metal oxide coating is that which produces a semi-transparent or transparent coating onto the SiO_{z} core material which exhibits an optical goniochromatic effect. The film thickness will vary dependent upon the pigment substrate and the optical goniochromatic effect desired.

The thickness of the layers is not critical per se and will in general range from 1 to 500 nm, preferably from 10 to 300 nm. Different oxides at different thickness produce different colors, depending on the refraction index of the oxide.

Once the addition of metal precursor material is completed and the desired metal oxide layer thickness is achieved, the metal core suspension can be filtered and washed with deionized water, dried and calcined at a temperature of about 100 to 900° C., preferably about 400 to about 600° C., especially about 450 to about 500° C., for about 15 to 30 minutes, most preferably under a non-oxidizing atmosphere.

Optionally, the effect pigments can be provided with an additional, outermost semi-transparent light absorbing metal oxide layer formed of, for example, Fe₂O₃, CoO, CoTiO₃, Cr₂O₃, Fe₂TiO₅ or a silicon suboxide SiOₓ, wherein x is less than one and preferably about 0.2. Said light absorbing metal oxide layer absorbs at least a portion of all but certain wavelengths of light to provide an enhanced impression of the selected color. The SiOₓ layer may be formed by known methods, for example, by thermally decomposing SiH₄ in the presence of the coated metal cores, in a fluidized bed reactor. The presence of the additional light absorbing layer can increase both the chroma and the color shift optical variance of the pigment. The additional light absorbing layer should have a thickness of 5 to 50 nm, preferably 5 to 30 nm.

The effect pigments formed in accordance with the present invention may be further subjected to post treatment (surface modification) using any conventionally known method to improve the weatherability, dispersibility and/or water stability of a pigment. The effect pigments of the present invention are suitable for use in imparting color to high molecular weight (10³ to 10⁸ g/mol) organic materials (plastics), glass, ceramic products, cosmetic compositions, ink compositions and especially coating compositions and paints. The effect pigments of the present invention may also be used to advantage for such purposes in admixture with transparent and hiding white, colored and black pigments, carbon black and transparent, colored and black luster pigments (i.e., those based on metal oxide coated mica), and metal pigments, including goniochromatic interference pigments based on metallic or non metallic core materials, platelet-shaped iron oxides, graphite, molybdenum sulfide and platelet-shaped organic pigments. The coloristic properties of the present effect pigments may also be altered by reacting said pigments in hydrogen, carbon monoxide, ammonia or a combination thereof to form a surface layer of reduced metal (for example Fe or Ti) oxide or nitride, which surface layer will cause the darkening of the pigment color.

A paint or coating composition according to the invention may comprise a film-forming vehicle compounded with the above described effect pigment. The film-forming vehicle of the inventive coating composition is not particularly limiting and any conventional resin can be used according to the intended application of the inventive coating composition. Examples of suitable film-forming vehicle resins include synthetic resins such as acrylic resins, polyester resins, resin mixtures of an acrylic resin and cellulose acetate butyrate (CAB), CAB-grafted acrylic resins, alkyd resins, urethane resins, epoxy resins, silicone resins, polyamide resins, epoxy-modified alkyd resins, phenolic resins and the like as well as various kinds of natural resins and cellulose derivatives. These film-forming vehicle resins can be used either singly or in combinations of two or more according to need. If necessary, the above named film-forming vehicle resins are used as combined with a curing agent such as melamine resins, isocyanate compounds, isocyanate compounds having a block-wise structure, polyamine compounds and the like.

In addition to the above described film-forming vehicle resins, chromatic-color metal flake pigments and colored pigments of other types optionally can be added to the composition. The coating composition of the invention can be admixed with various kinds of additives conventionally used in coating compositions including, for example, surface conditioning agents, fillers, plasticizers, stabilisers, antioxidants and the like according to need.

The form of the inventive coating composition is not particularly limiting and includes dispersions in an organic solvent, aqueous dispersions, powders and emulsions. The process for film-forming of the inventive coating composition can be performed by drying at room temperature, curing by baking and curing by the irradiation with ultraviolet light or electron beams without particular limitations.

When the inventive coating composition is in the form of a dispersion in an organic solvent, the solvent suitable therefore is not particularly limiting and includes those organic solvents used conventionally in solution-type coating compositions. Examples of suitable organic solvents include aromatic hydrocarbon solvents such as toluene, xylene and the like, olefin compounds, cycloolefin compounds, naphthas, alcohols such as methyl, ethyl, isopropyl and n-butyl alcohols, ketones such as methyl ethyl ketone and methyl isobutyl ketone, esters such as ethyl acetate and butyl acetate, chlorinated hydrocarbon compounds such as methylene chloride and trichloroethylene, glycol ethers such as ethylene glycol monoethyl ether and ethylene glycol monobutyl ether, glycol monoether monoesters such as ethylene glycol monomethyl ether acetate and ethylene glycol monoethyl ether acetate and so on.

The coating composition of the present invention can be prepared via any method used for the preparation of conventional coating compositions of the respective type. The coating composition of the invention can be applied to any substrate material including, for example, metal, wood, plastic, glass, ceramic and the like without particular limitations. The coating method is also not particularly limiting and any conventional coating methods can be undertaken including, for example, air-spray coating, airless coating, electrostatic coating, rollcoater coating and the like. The coating can be applied using a one-coat method, two-coat method and so on depending on the intended application of the coated articles.

An ink composition of the present invention contains a film-forming material and a coloring agent comprising the above described metallic effect pigment. All film-forming materials used to form conventional ink compositions may be used to form the ink compositions of the present invention without particular limitation. Examples of film-forming materials suitable for such purposes include, for example, synthetic resins such as phenolic resins, alkyd resins, polyamide resins, acrylic resins, urea resins, melamine resins and polyvinyl chloride resins, natural resins such as Gilsonite, cellulose derivatives and vegetable oils such as linseed oil, tung oil and soybean oil. Optionally, two or more kinds of such film-forming materials may be used in combination according to the intended application of the ink composition.

In addition to the above described film-forming material, chromatic-color metal core pigment and colored pigments optionally added according to need, the ink composition of the present invention can be admixed with various kinds of additives conventionally used in ink compositions such as waxes, plasticizers, dispersing agents and the like according to need. Further, the form of the inventive ink composition is not particularly limited and includes solutions in an organic solvent, aqueous solutions and aqueous emulsions.

When the inventive ink composition is in the form of a dispersion in an organic solvent, various kinds of organic solvents can be used therefore without particular limitations and include those used in conventional solution-type ink compositions. Examples of suitable organic solvents include, for example, aromatic hydrocarbon solvents such as toluene and xylene, olefin compounds, cycloolefin compounds, naphthas, alcohols, such as methyl, ethyl, isopropyl and n-butyl alcohols, ketones such as methyl ethyl ketone and methyl isobutyl ketone, esters such as ethyl acetate and butyl acetate, chlorinated hydrocarbon compounds such as methylene chloride and trichloroethylene glycol ethers such as ethylene glycol monoethyl ether and ethylene glycol monobutyl ether, glycol monoether monoesters such as ethylene glycol monomethyl ether acetate and ethylene glycol monoethyl ether acetate and so on.

The inventive ink composition can be prepared via any method used in the preparation of prior art to form conventional ink compositions of the respective types. The ink composition of the invention can be used in printing in any conventional manner such as screen printing, rotogravure, bronze printing, and flexographic printing.

A colored molding material in accordance with the present invention contains a plastic resin and, as the coloring agent, the above-described metallic effect pigment. The plastic resin which constitutes the principal ingredient of the inventive molding compound is not particularly limited and any plastic resins conventionally used in the prior art for molding of shaped articles can be employed. Examples of such plastic resins include polyvinyl chloride resins, plasticized polyvinyl chloride resins, polyethylene resins, polypropylene resins, ABS resins, phenolic resins, polyamide resins, alkyd resins, urethane resins, melamine resins and the like.

Optionally, the plastic resin of the inventive molding compound is compounded with other chromatic-color metal flake pigments and/or with colored pigments of other types to further enhance the aesthetic coloring effect. The inventive molding compound of plastic resin may also optionally contain various kinds of fillers and other additives conventionally used in plastic resin-based molding compounds of the prior art. Various forms of shaped articles can be prepared from the inventive molding compound by a known method such as by extrusion molding and injection molding.

Thus, the invention also pertains to a composition comprising a high molecular weight organic material and a coloristically effective amount of an instant effect pigment, as well as to the use of the instant effect pigments for pigmenting a high molecular weight organic material, in particular an automotive coating. The instant pigment is preferably used in amounts of from 0.01 to 30% by weight, based on the weight of the high molecular weight organic material to be pigmented.

The following examples are for illustrative purposes only and are not to be construed to limit the scope of the instant invention in any manner whatsoever.

### EXAMPLE 1

In a vacuum system which in its fundamental points is constructed analogously to U.S. Pat. No. 6,270,840, or as an alternative in a batch system, the following are vaporized, from vaporizers, in succession: sodium chloride (NaCl) as separating agent at about 900° C., and silicon monoxide (SiO) as reaction product of Si and SiO₂ at from 1350 to 1550° C. The layer thickness of NaCl is typically 30-40 nm, that of SiO being, depending on the intended purpose of the end product, from 20 to 2000 nm, in the present case 200 nm. The resistance-heated vaporizers are so configured in accordance with the known art that good uniformity is obtained over the working width. Vaporization is carried out at about 0.02 Pa, amounting to about 11 g of NaCl and 72 g of SiO per minute. For subsequently detaching the layers by dissolution of the separating agent, the carrier on which vapor-deposition has taken place is sprayed at about 3000 Pa with deionized water and treated with mechanical assistance using scrapers and with ultrasound. The NaCl enters solution, the SiO_{y} layer, which is insoluble, breaks up into flakes. The suspension is continuously removed from the dissolution chamber and, at atmospheric pressure, is concentrated by filtration and rinsed several times with deionised water in order to remove Na⁺ and Cl⁻ ions that are present. That is followed by the steps of drying and (for the purpose of oxidizing SiO_{y} to SiO_{z}) heating the plane-parallel SiO_{y} structures in the form of loose material at 700° C. for two hours in an oven through which air heated to 700° C. is passed. After cooling, comminution and grading by air-sieving are carried out. The product can be delivered for further use.

### EXAMPLE 2

0.5 g silicon oxide flakes, 150 g deionized water and 26.5 ml boric acid aqueous solution (0.8 M, 21.2 mmol) are stirred together to form a slurry. It is pumped in a continuous loop through a microwave oven. To the slurry is added 2 ml ammonium hexafluorostannate (0.1 M, 0.2 mmol) with syringe pump at the rate of 0.4 ml/min. 30 minutes after this addition, 50 ml ammonium hexafluorotitanate (0.2 M, 10.0 mmol) is added at the same rate. Another 30 minutes is allowed for the reaction to complete. The temperature is maintained at 50° C. during the entire process by adjusting the power level and operating time of the microwave. The solid is isolated from bulk solution by sediment and decantation. This solid is slurried with deionized water. Sedimentation and decantation are repeated. Finally, the solid is collected on a filtration funnel, washed with deionized water and dried. Further drying is carried out in vacuum oven at 110° C.

### EXAMPLE 3

1 g silicon dioxide flakes, 375 g deionized water and 8 ml boric acid solution (0.8 M, 6.4 mmol) are stirred together to form a slurry. The slurry is pumped in a continuous loop through a microwave oven. To the slurry is added 2 ml ammonium hexafluorostannate (0.1 M, 0.2 mmol) with a syringe pump at a rate of 0.4 ml/min. 30 minutes after this addition, 15 ml ammonium hexafluorotitanate (0.2 M, 3.0 mmol) are added at the same rate and the reaction is continued for another 30 minutes until completion. The temperature is maintained at 50° C. during the entire process by adjusting the power level and operating time of the microwave oven. The solid is isolated from bulk solution by sedimentation and decantation. The solid is slurried with deionized water and the sedimentation and decantation is repeated. The solid is collected on a filtration funnel, washed with deionized water, dried and finally dried in a vacuum oven at 110° C.

### EXAMPLE 4

1 g silicon dioxide flakes, 300 g deionized water and 14 ml boric acid solution (0.8 M, 11.2 mmol) are stirred together to form a slurry. The slurry is pumped in a continuous loop through a microwave oven. To the slurry is added 5 ml ammonium hexafluorostannate (0.1 M, 0.5 mmol) with syringe pump at a rate of 0.4 ml/min. 30 minutes after this addition, 25 ml ammonium hexafluorotitanate (0.2 M, 5.0 mmol) are added at the same rate and the reaction is continued for another 30 minutes until completion. The temperature is maintained at 50° C. during the entire process by adjusting the power level and operating time of the microwave. The solid is isolated from bulk solution by sedimentation and decantation. The solid is slurried with deionized water and the sedimentation and decantation is repeated. The solid is put on a filtration funnel, washed with deionized water, dried and finally dried in a vacuum oven at 110° C.

### EXAMPLE 5

1 g silicon dioxide flakes, 300 g deionized water and 45 ml boric acid solution (0.8 M, 36 mmol) are stirred together to form a slurry. The slurry is pumped in a continuous loop through a microwave oven. To the slurry is added 5 ml ammonium hexafluorostannate (0.1 M, 0.5 mmol) with syringe pump at a rate of 0.4 ml/min. 30 minutes after this addition, 80 ml ammonium hexafluorotitanate (0.2 M, 16 mmol) is added at the same rate and the reaction is continued for another 30 minutes until completion. The temperature is maintained at 50° C. during the entire process by adjusting the power level and operating time of the microwave. The solid is isolated from bulk solution by sediment and decantation. The solid is slurried with deionized water and the sedimentation and decantation is repeated. The solid is collected on a filtration funnel, washed with deionized water, dried and finally dried in a vacuum oven at 110° C.

### EXAMPLE 6

0.4 g Graphitan 7525 (graphite platelets) and 75 ml boric acid aqueous solution (0.8 M, 60 mmol) are stirred together to form a slurry. It is pumped into a coil of PTFE tubing which runs through a microwave oven. With microwave irradiation 25 ml ammonium hexafluorotitanate aqueous solution (0.4 M, 10 mmol) is added to the mixture at 0.3 ml/min and the microwave treatment reaction is continued for another 30 minutes. The temperature is maintained between 55-65° C. during the process by adjusting the power level and operating time of the microwave. The solid is collected by filtration, then washed with deionized water and air dried. Further drying is carried out in vacuum oven at 110° C. The pigments exhibit a dark blue color.

### EXAMPLE 7

0.3 g silicon oxide flakes (thickness 300 nm) and 75 ml boric acid aqueous solution (0.8 M, 60 mmol) are stirred together to form a slurry. The slurry is pumped into a coil of PTFE tubing which runs through a microwave oven. With microwave irradiation 25 ml ammonium hexafluorotitanate aqueous solution (0.4 M, 10 mmol) is added to the mixture at 0.2 ml/min and the microwave treatment continued for another 30 minutes. The temperature is maintained between 50-60° C. during the process by adjusting the power level and operating time of the microwave. The solid is collected by filtration, then washed with deionized water and air dried. Further drying is carried out in vacuum oven at 110° C. The obtained pigments exhibit a green color.

### EXAMPLE 8

0.2 g silicon oxide flakes (thickness 150 nm) and 45 ml boric acid aqueous solution (0.8 M, 36 mmol) are stirred together to form a slurry. The slurry is pumped into a coil of PTFE tubing which runs through a microwave oven. 15 ml ammonium hexafluorotitanate aqueous solution (0.4 M, 6 mmol) is added to the mixture at 0.8 ml/min at ambient temperature. With microwave irradiation the temperature is maintained between 30-40° C. for 90 minutes and 50-65° C. for 30 minutes. The solid is collected by filtration, then washed with deionized water and air dried. Further drying is carried out in vacuum oven at 110° C. The obtained pigments exhibit a red color.

### EXAMPLE 9

0.3 g silicon oxide flakes (thickness 150 nm) and 75 ml boric acid aqueous solution (0.8 M, 60 mmol) are stirred together to form a slurry. The slurry is pumped into a coil of PTFE tubing which runs through a microwave oven. With microwave irradiation 25 ml ammonium hexafluorotitanate aqueous solution (0.4 M, 10 mmol) is added to the mixture at 0.3 ml/min and the microwave treatment continued for another 30 minutes. The temperature is maintained between 55-65° C. during the process by adjusting the power level and operating time of the microwave. The solid is collected by filtration, then washed with deionized water and air dried. Further drying is carried out in vacuum oven at 110° C. The obtained pigments exhibit a green color.

### EXAMPLE 10

0.24 g silicon oxide flakes (thickness 150 nm) and 20 ml deionized water are stirred together to form a slurry. The slurry is pumped into a coil of PTFE tubing which runs through a microwave oven. 18 ml aqueous solutions of FeCl₃.NH₄F (0.4 M, 7.2 mmol) and 18 ml boric acid aqueous solution (0.8 M, 14.4 mmol) are added to the mixture simultaneously at 0.2 m/min at ambient temperature. The reaction is then treated with microwave irradiation for 30 minutes at 40-50° C. The solid is collected by filtration, then washed with deionized water and air dried. Further drying is carried out in vacuum oven at 110° C. The obtained pigments exhibit a green/yellow color.

### EXAMPLE 11

Example 4 is repeated, except that silicon dioxide flakes are used which have a thickness of about 100 nm, and the titanium dioxide deposition is stopped after a layer thickness of titanium dioxide of about 90 nm is reached. The obtained flakes exhibit a red color.

### EXAMPLE 12

Example 7 is repeated, except that SiO_{z} (≈1.6≦z≦1.8) flakes are used which have a thickness of about 100 nm, and the titanium dioxide deposition is stopped after a layer thickness of titanium dioxide of about 90 nm is reached. The obtained flakes exhibit a red color.

1. A process for the preparation of a pigment comprising a core material and at least one dielectric layer consisting of one or more oxides of a metal selected from the group 3 to 15 of the periodic table, comprising the steps of:
(a) suspending the core material in an aqueous solution of fluorine scavenger;
(b) adding an aqueous solution of one or more fluorine containing metal complexes which are the precursors of the desired metal oxide coating; and
(c) subjecting said suspension to microwave radiation to deposit the metal oxide onto said core material.

2. The process according to claim 1, wherein the pigment is an effect pigment comprising a core material and at least one dielectric layer consisting of one or more oxides of a metal selected from the group 3 to 15 of the periodic table.

3. The process according to claim 2, wherein the core material is platelet-shaped material having a low index of refraction selected from the group consisting of mica, another layer silicate, Al₂O₃ and SiO_{z}.

4. The process according to claim 3, wherein the SiO_{z} or the layer silicate is selected from the group consisting of SiO₂, SiO₂/SiOₓ/SiO₂, SiO_{1.40-2.0}/SiO_{0.70-0.99}/SiO_{1.40-2.0} and Si/SiO_{z}, wherein 0.03≦x≦0.95 and 0.70≦z≦2.0.

5. The process according to claim 2, wherein the core material is platelet-shaped material having a high index of refraction, wherein the high index of refraction is greater then 1.65.

6. The process according to claim 5 wherein the material of high index of refraction is TiO₂ or Fe₂O₃.

7. The process according to claim 2, wherein the core material is platelet-shaped metallic material selected from the group consisting of titanium, silver, aluminum, copper, chromium, iron, germanium, molybdenum, tantalum, and nickel.

8. The process according to claim 1, wherein the pigment is a metal oxide coated pigment comprising pigment particles and at least one dielectric layer consisting of one or more oxides of a metal selected from the group 3 to 15 of the periodic table.

9. The process according to claim 1, wherein the core material is an organic, or inorganic pigment.

10. The process according to claim 1, wherein the fluorine scavenger is selected from the group consisting of boric acid and an alkali metal borate which alkali metal borate is selected from the group consisting of sodium borate, ammonium borate, boron anhydride and boron monoxide.

11. The process according to claim 1, wherein the fluorine containing metal complex is selected from the group consisting of ammonium hexafluorotitanate; ammonium hexaflurostanate; ammonium hexafluorosilicate; iron(III) chloride, hydrofluoric acid and ammonium fluoride mixture; aluminum(III) chloride, hydrofluoric acid, and ammonium fluoride mixtures; ammonium hexafluorogermanate; indium(III) fluoride, hydrofluoric acid and ammonium fluoride mixture; and combinations of metal complexes to form metal oxide films comprising more than one element and indium tin oxide film.

12. The process according to claim 1, wherein the metal oxide is titanium dioxide and the fluorine containing metal complex is ammonium hexafluorotitanate, a complex prepared from ammonium fluoride and titanium chloride, or titanium chloride, ammonium fluoride, and hydrogen fluoride; or the metal oxide is silicon dioxide and the fluorine containing metal complex is ammonium hexafluorosilicate or ammonium pentafluorosilicate.

13. The process according to claim 1, further comprising the steps of:
(d) adding an aqueous solution of one or more fluorine containing metal complexes which are the precursors of the desired metal oxide coating which is different that the oxide coating in step (b); and
(e) subjecting said suspension to microwave radiation to deposit the metal oxide onto said coated core material.

14. The process according to claim 11, wherein the fluorine containing metal complex of step (b) is ammonium hexafluorotitanate and the fluorine containing metal complex of step (d) is an ammonium fluorosilicate salt.

15. The process according to claim 1, wherein the core material is SiO_{z} with 1.40≦z<2.0 or SiO₂ and the first dielectric layer is a metal oxide of high refractive index, and an optionally present second dielectric layer is a metal oxide of low refractive index, wherein the difference of the refractive indices is at least 0.1;
the core material is platelet-like graphite and the dielectric layer is of titanium dioxide; the core material is titanium dioxide and the first dielectric layer is selected from the group consisting of Fe₂O₃, Fe₃O₄, FeOOH, Cr₂O₃, CuO, Ce₂O₃, Al₂O₃, SiO₂, BiVO₄, NiTiO₃, CoTiO₃ and antimony-doped, fluorine-doped or indium-doped tin oxide iron oxide, and an optionally present second dielectric layer is selected from the group consisting of aluminium oxide or aluminium oxide hydrate, silicon dioxide or silicon dioxide hydrate, Fe₂O₃, Fe₃O₄, FeOOH, TiO₂, ZrO₂, Cr₂O₃ and antimony-doped, fluorine-doped or indium-doped tin oxide; or
the core material is iron oxide and the first dielectric layer is a colorless coating having a refractive index n≦1.8, and an optionally present second dielectric layer is a colorless coating having a refractive index ≧2.0.

16. SiO_{z} with 1.40≦z<2.0 or SiO₂ flakes having a thickness of 70 to 130 nm, comprising a titanium dioxide layer having a thickness of 60 nm to 120 nm.
